(19) United States
(12) Patent Application Publication
(10) Pub. No.: US 2012/0079483 A1
(43) Pub. Date: Mar. 29, 2012

(54) Computer Implemented Automatic Lock Insertion in Concurrent Programs

(75) Inventor: Vineet Kahlon, Princeton, NJ (US)

(73) Assignee: NEC LABORATORIES AMERICA, INC., Princeton, NJ (US)

(21) Appl. No.: 13/246,974

(22) Filed: Sep. 28, 2011

Related U.S. Application Data
(60) Provisional application No. 61/387,606, filed on Sep. 29, 2010.
(60) Provisional application No. 61/514,650, filed on Aug. 3, 2011.

(51) Int. Cl. G06F 9/46

(52) U.S. Cl. 718/100

(57) ABSTRACT

Method provides a fully automatic lock insertion procedure to enforce critical sections that guarantees deadlock freedom and tries to minimize the lengths of the resulting critical sections. Method encapsulates regions of code meant to be executed atomically in a critical section induced by a pair of lock unlock statements and enlarges the critical section of the first thread by propagating the newly introduced lock statement backwards till it no longer participates in a deadlock. If the newly introduced lock statement participates in a deadlock, the process terminates. If lock statement of the second thread participates in a deadlock the method enlarges the critical section of the second thread by propagating the newly introduced lock statement backwards until it no longer participates in a deadlock.

This application claims the benefit of U.S. Provisional Application No. 61/514,650, Docket No. 10047P2, entitled, “Automatic Nested and Non-nested Lock Insertion in Concurrent Programs”, filed Aug. 3, 2011; and claims the benefit of U.S. Provisional Application No. 61/387,606, Docket No. 10047P, entitled, “Automatic Lock Insertion in Concurrent Programs”, filed Sep. 29, 2010, of which the contents of both are incorporated herein by reference.

### BACKGROUND OF THE INVENTION

The present invention relates generally to detecting errors in concurrent programs, and more specifically, a computer implemented method for automatic lock insertion in concurrent programs.

Triggering errors in concurrent programs is a notoriously difficult task. A key reason for this is the behavioral complexity resulting from the large number of interleavings of operations of different threads. An even more challenging task is fixing errors once they are detected. In general, synthesizing a correct program from a buggy one is a near impossible task. However, for simple correctness properties that depend on the syntactic structure of the program rather than its semantics automatic error correction becomes feasible. Applicant considers the program of lock insertion to enforce critical sections required to fix bugs like data races and atomicity violations. A key challenge in lock insertion is that enforcing a critical section is often not the sole criterion that needs to be satisfied. Often other correctness constraints like deadlock-freedom also need to be met. Moreover, apart from ensuring correctness, another key concern during lock insertion is performance. Indeed, mutual exclusion constraints generated by locks kills parallelism thereby impacting performance. Thus, it is critical that the sizes of the newly introduced critical sections be kept as small as possible. In other words, the goal of the invention is lock insertion while meeting the dual and often conflicting constraints of (i) correctness and (ii) performance.

One existing method provides a technique for lock allocation for a program starting from scratch, i.e., where no lock exists in the given program. However, this technique does not apply to bug fixing where there already exist locks in the given code that may possibly be non-nested. This existing method side-steps issues arising from deadlocks by acquiring locks in a nested fashion in a fixed global order. Since this existing technique cannot guarantee avoidance of deadlock, if locks are already present in the given code, this technique can be used for initial lock allocation AND not lock insertion.

Accordingly, there is a need for a fully automatic, efficient and precise technique for lock insertion in concurrent code that ensures deadlock freedom while attempting to minimize the lengths of the resulting critical sections.

### BRIEF SUMMARY OF THE INVENTION

The present invention is directed to a computer implemented method that provides for a fully automatic, efficient and precise technique for lock insertion in concurrent code that ensures deadlock freedom while attempting to minimize the lengths of the resulting critical sections.

In a preferred embodiment of the invention, there is provided a computer implemented method for a fully automatic lock insertion procedure to enforce critical sections that guarantees deadlock freedom and tries to minimize the lengths of the resulting critical sections. In order to ensure that lengths of the newly introduced critical sections are as small as possible, the method starts by encapsulating the regions of code meant to be executed atomically in a critical section induced by a pair of lock unlock statements. While this guarantees critical sections of the least possible size, it does not guarantee deadlock freedom. In order to ensure deadlock freedom the method enlarges the critical section of the first thread by propagating the newly introduced lock statement backwards till it no longer participates in a deadlock. If neither of the newly introduced lock statements participates in a deadlock, the process terminates. On the other hand, if the lock statement of the second thread participates in a deadlock then the method enlarges the critical section of the second thread by propagating the newly introduced lock statement backwards until it no longer participates in a deadlock. This process of enlarging the newly introduced critical sections of threads one and two in a dovetailed fashion is continued until none of the newly introduced lock statements participates in a deadlock.

More specifically, the inventive computer implemented method includes, responsive to code segments s and t in two different threads with nested locks to be executed atomically, introducing a lock statement for a new lock I before the first statement in each segment and introducing unlock statements for I after said last statement in each segment; if the statement locking I in thread one is involved in a deadlock, said statement is propagated backwards till it either reaches a pairwise unreachable global state or it is no longer involved in a deadlock, determined reachability responsive to one of a determined multi universal causality graph for said two code segments or determined acquisition histories in individual said threads for each said lock statement in said two code segments; if the statement locking I in thread two is involved in a deadlock, the statement is propagated backwards until the statement either reaches a pairwise unreachable global state or it is no longer involved in a deadlock, determined reachability responsive to one of a determined multi universal causality graph for the two code segments or determined acquisition histories in individual said threads for each said lock statement in the two code segments; if either of the statements locking I in threads one and two participate in a deadlock then the prior two if steps are repeated; if neither of the statements locking I in threads one and two participate in a deadlock, the current critical sections being outputted with or without first adding unlock statements to match newly introduced lock statements while preserving nestedness; wherein the critical sections outputted enable a modified said concurrent program with atomic sections enforced by said newly introduced lock statements.

These and other advantages of the invention will be apparent to those of ordinary skill in the art by reference to the following detailed description and the accompanying drawings.

### BRIEF DESCRIPTION OF THE DRAWINGS

FIG. 1 depicts in block diagram form an exemplary architecture for implementing the inventive automatic lock insertion procedure;

FIG. 2 is a flow diagram for a computer implemented automatic lock insertion in concurrent programs, in accordance with the invention; and

FIG. 3 is a flow diagram of application of the automatic lock insertion of FIG. 2 applied to concurrent programs with nested locks, in accordance with the invention;

### DETAILED DESCRIPTION

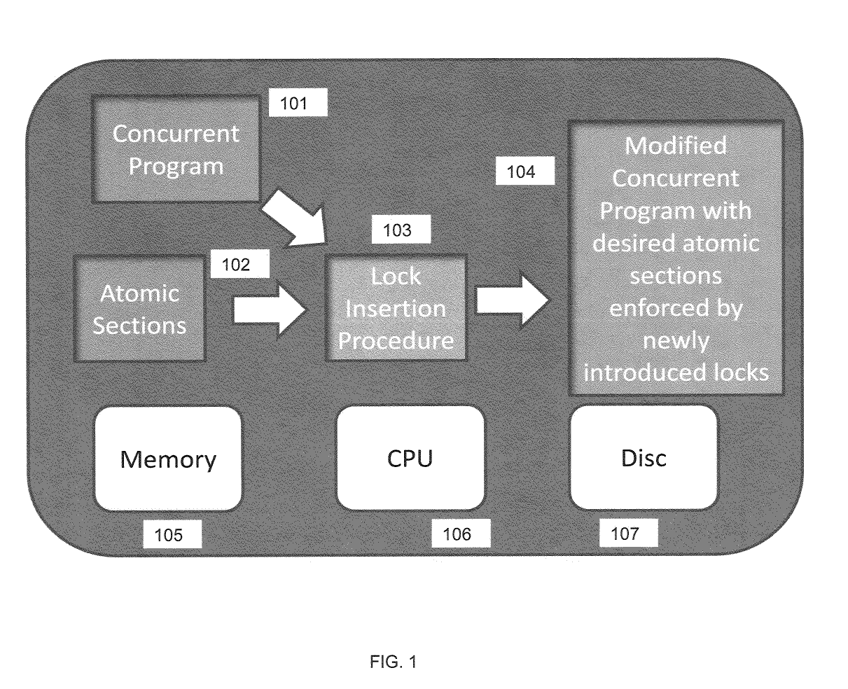

The present invention is directed to a computer-implemented method that provides for a fully automatic, efficient and precise technique for lock insertion in concurrent code that ensures deadlock freedom while attempting to minimize the lengths of the resulting critical sections. Referring to the architecture configuration of FIG. 1, including memory 105, CPU 106 and disc storage 107, the inventive lock procedure 103 is responsive to a concurrent program 101 and atomic sections 102 to enable a modified concurrent program with desired atomic section enforced by newly introduced locks determined by the inventive lock procedure 103.

The present invention provides a fully automatic lock insertion procedure to enforce critical sections that guarantees deadlock freedom and tries to minimize the lengths of the resulting critical sections. In order to ensure that lengths of the newly introduced critical sections are as small as possible, the inventive method starts by encapsulating the regions of code meant to be executed atomically in a critical section induced by a pair of lock unlock statements. While this guarantees critical sections of the least possible size it does not guarantee deadlock freedom. In order to ensure deadlock freedom we enlarge the critical section of the first thread by propagating the newly introduced lock statement backwards till it no longer participates in a deadlock. If neither of the newly introduced lock statements participates in a deadlock the process terminates. On the other hand, if the lock statement of the second thread participates in a deadlock then we enlarge the critical section of the second thread by propagating the newly introduced lock statement backwards till it no longer participates in a deadlock. This process of enlarging the newly introduced critical sections of threads one and two in a dovetailed fashion is continued till none of the newly introduced lock statements participates in a deadlock.

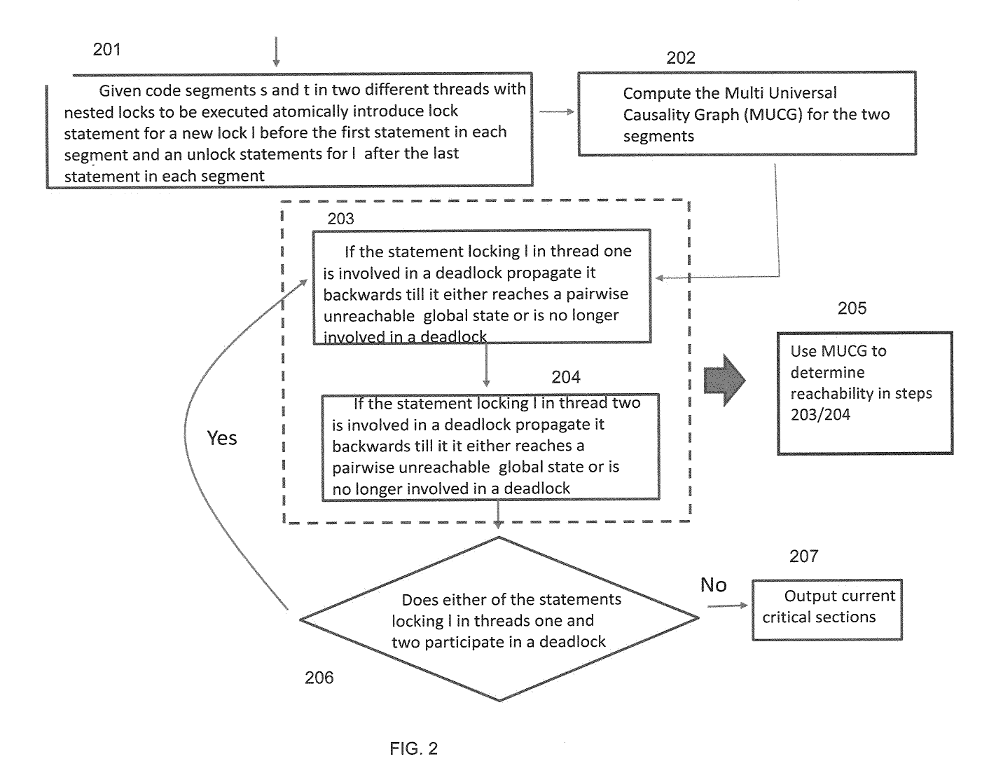

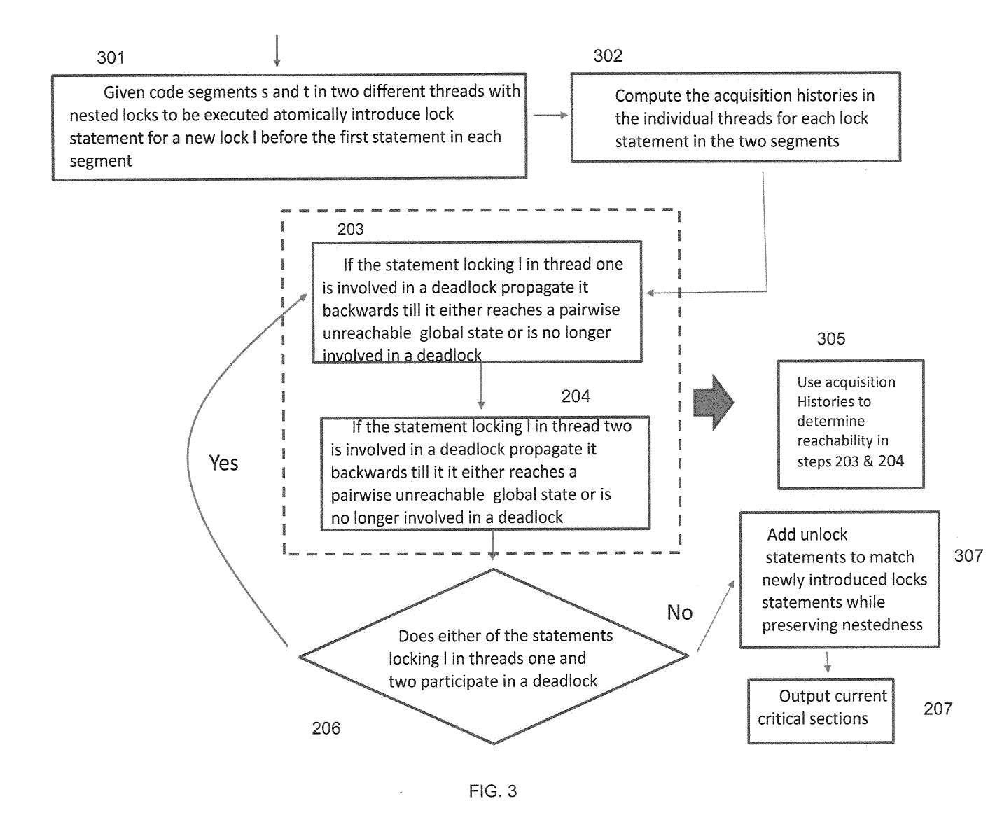

The present invention formulates two different procedure for lock insertion one for general locking patterns (FIG. 2) and another for programs with nested locks (FIG. 3). The method entails a specialized procedure for programs with nested locks as the general locking procedure when applied to programs with nested locks does not preserve nestedness of locks as is often required by software guidelines. The specialized procedure for nested locks ensures that nestedness is preserved and is also more efficient that the general procedure.

Referring now to the flow diagram of FIG. 2, shown are the steps of the computer implemented lock insertion method according to the invention.

Given code segments s and t in two different threads with nested locks to be executed atomically, the method introduces a lock statement for a new lock I before the first statement in each segment and introduces unlock statements for I after the last statement in each segment 201. Then a multi universal causality graph (MUCG) for the two segments is computed 202.

If the statement locking I in thread one is involved in a deadlock, the statement is propagated backwards till it either reaches a pairwise unreachable global state or it is no longer involved in a deadlock 203. If the statement locking I in thread two is involved in a deadlock, the statement is propagated backwards until the statement either reaches a pairwise unreachable global state or it is no longer involved in a deadlock 204. The MUCG is used to determine reachability 205 in steps 203 and 204.

If either of the statements locking I in threads one and two participate in a deadlock 206, the method loops back through steps 203 and 204. If neither of the statements locking I in threads one and two participate in a deadlock 206, then the current critical sections are outputted.

Referring now to the flow diagram of FIG. 3, shown are the locking statement steps 203 and 204 employed for an efficient lock insertion procedure for concurrent programs with nested locks.

Given code segments s and t in two different threads with nested locks to be executed atomically, the method introduces a lock statement for a new lock I before the first statement in each segment 301. Then, the acquisition histories in the individual threads for each lock statement in the two segments are computed 302.

If the statement locking I in thread one is involved in a deadlock, the statement is propagated backwards until it either reaches a pairwise unreachable global state or it is no longer involved in a deadlock 203. If the statement locking I in thread two is involved in a deadlock, the statement is propagated backwards until the statement either reaches a pairwise unreachable global state or it is no longer involved in a deadlock 204. The acquisition histories 305 are used to determine reachability in steps 203 and 204.

If either of the statements locking I in threads one and two participate in a deadlock 206, the method loops back through steps 203 and 204. If neither of the statements locking I in threads one and two participate in a deadlock 206, the method adds unlock statements to match newly introduced lock statements while preserving nestedness and then current critical sections are outputted 207.

From the foregoing, it can be appreciated that the inventive computer implemented method for automatic lock insertion for concurrent programs reduces time for fixing standard concurrency bugs by carrying it out automatically; guarantees optimality of newly introduced critical section improving performance for straight-line code; and guarantees correctness of bug fixes.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A computer implemented method for automatically inserting locks in a concurrent program comprising the steps of:
i) encapsulating regions of program code in a concurrent program that are meant to be executed atomically in a critical section induced by first and second lock statements, said encapsulating guaranteeing said critical sections being of a least possible size;
ii) enlarging said critical section of a first thread by propagating the newly introduced said lock statements backwards till they no longer participate in a deadlock thereby ensuring deadlock freedom;
iii) if neither of said newly introduced lock statements participates in a deadlock the computer implemented method terminates;
iv) if said lock statement of a second thread participates in a deadlock then there is an enlarging of said critical section of said second thread by propagating said newly introduced lock statement backwards till it no longer participates in a deadlock, said enlarging of said newly introduced critical sections of threads one and two in a dovetailed fashion is continued till none of the newly introduced lock statements participates in a deadlock;
wherein said steps i)-iv) providing a fully automatic lock insertion to enforce said critical sections that guarantees deadlock freedom and minimizes lengths of resulting said critical sections in said concurrent program.

2. A computer implemented method for automatically inserting locks in a concurrent program comprising the steps of:
i) responsive to code segments s and t in two different threads with nested locks to be executed atomically, introducing a lock statement for a new lock I before said first statement in each segment and introducing unlock statements for I after said last statement in each segment;
ii) if said statement locking I in thread one is involved in a deadlock, said statement is propagated backwards till it either reaches a pairwise unreachable global state or it is no longer involved in a deadlock, determined reachability responsive to one of a determined multi universal causality graph for said two code segments or determined acquisition histories in individual said threads for each said lock statement in said two code segments;
iii) if said statement locking I in thread two is involved in a deadlock, said statement is propagated backwards until said statement either reaches a pairwise unreachable global state or it is no longer involved in a deadlock, determined reachability responsive to one of a determined multi universal causality graph for said two code segments or determined acquisition histories in individual said threads for each said lock statement in said two code segments;
iv) if either of the statements locking I in threads one and two participate in a deadlock, repeating steps ii) and iii);
v) if neither of the statements locking I in threads one and two participate in a deadlock, said current critical sections being outputted with or without first adding unlock statements to match newly introduced said lock statements while preserving nestedness;
wherein said critical sections outputted enabling a modified said concurrent program with atomic sections enforced by said newly introduced lock statements.
